(19) United States
(12) Patent Application Publication
(10) Pub. No.: US 2004/0160874 A1
(43) Pub. Date: Aug. 19, 2004

(54) Method of automatically optimizing writing on optical recording medium and optical recording/reproducing apparatus for performing the same

(75) Inventors: Wook-Yeon Hwang, Gyeonggi-do (KR); Yong-Jin Ahn, Seoul (KR); Tatsuhiro Otsuka, Gyeonggi-do (KR); In-sik Park, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG Electronics Co., Ltd., Suwon-city (KR)

(21) Appl. No.: 10/684,837

(22) Filed: Oct. 15, 2003

(30) Foreign Application Priority Data
Oct. 30, 2002 (KR) 2002-66574

(51) Int. Cl. G11B 7/00

(52) U.S. Cl. 369/47.53; 369/59.11; 369/53.34

(57) ABSTRACT

A method of optimizing recording conditions of an optical recording medium and an apparatus using the method. The method includes recording a test write pattern in a plurality of tracks of the optical recording medium; and checking a quality of a radio frequency signal reproduced from one of the plurality of tracks in which the predetermined write pattern is recorded and which is effected by writing in adjacent tracks to determine the optimized recording conditions.

### CROSS-REFERENCE TO RELATED APPLICATIONS

This application claims the priority of Korean Patent Application No. 2002-66574, filed Oct. 30, 2002, in the Korean Intellectual Property Office, the disclosure of which is incorporated herein in its entirety by reference.

### BACKGROUND OF THE INVENTION

1. Field of the Invention

The present invention relates to the field of the writing optimization of an optical recording medium, and more particularly, to a method of automatically optimizing writing on an optical recording medium and an optical recording and/or reproducing apparatus for performing the method.

2. Description of the Related Art

Conventional methods of optimizing writing on an optical recording medium applied to digital versatile disc-random access memories (DVD-RAMs) are known. However, these methods confine the structure of a disc to nucleation dominant technology. Writing optimization methods for rewritable discs such as rewritable compact discs (CD-RWs), DVD-RWs, and so forth, employing a fast growth method, or next generation high-density optical discs are not yet known.

As an example of the conventional writing optimization method, International Patent Publication No. WO 2001/11614, entitled “Trial Writing Method and Optical Disc Device Using the Same” assigned to Hitachi Co., discloses a method of optimizing writing by minimizing phase shift. In other words, when data is recorded with a varying write power in a predetermined pattern composed of a mark and a space and then reproduced, a phase difference between an edge of the write pattern and an edge of a phase lock loop (PLL) clock is extracted as an error pulse. A minimum condition (shift amount) is obtained from a table classifying and storing phase differences (error pulses) according to combinations of marks and spaces and a process of rewriting the write pattern on and reproducing the write pattern from a disc is repeated to determine an optimum write pulse width and power in which a phase difference is minimum. In this method, the write pattern is written on and reproduced from the disc while varying a power, a pulse width, and a position or varying a combination of the power, the pulse width, and the position to detect a write condition in which the number of error pulses of each component is minimum.

As another example of the conventional writing optimization method, Japanese Patent Publication No. 2000-251256, entitled “Recording Apparatus and Laser Power Setting Method,” discloses a method of obtaining write and erase powers having an optimum asymmetry value. In this method, random data is written in a test write pattern and then reproduced while varying a laser power to obtain a ratio of a write power Pw to an erase power Pe (a ratio of Pw to Pe in optimum jitter and asymmetry is constant) in which jitter or an error rate is optimum and to reduce the time required for writing and reproducing data. Also, by using a single pattern, marks having a maximum length T (bit gap) are written in n tracks and marks having a minimum length T are written in and reproduced from n+2 tracks to obtain write and erase powers where an asymmetry value is optimum.

As still another example of the conventional writing optimization method, a document, entitled “New Method of Calibrating Adaptive Writing Pulses for DVD-RAM 4.7 GB Drive,” JJAP Vol., 40(2001) 1694-1697, discloses a method of optimizing writing by minimizing jitter. In other words, after a write power is optimized according to an asymmetry calibrating method, edges of a mark, i.e., first and last pulses of write pulses, shift so as to minimize jitter. Also, this method can be applied to a predetermined write pattern composed of a mark and a space to classify, write, and reproduce the predetermined write pattern, calculate jitter of a radio frequency (RF) signal, and shift the write pulses so as to minimize jitter.

However, conventional writing optimization techniques are restricted to DVD-RAM type of media among rewritable media using a nucleation method producing a relatively low cross-erase rate. Also, conventionally, a method of determining a write power using only an asymmetry value is mainly presented. However, this method does not satisfy optimum writing conditions. The need for considering cross-erase caused during writing or cross-talk caused during reproduction, which may affect writing quality, is raised in high-density recording, which is a recent optical writing tendency.

### SUMMARY OF THE INVENTION

Accordingly, the present invention provides a method of automatically optimizing writing on an optical recording medium using a fast growth method as well as a general nucleation method and an optical recording and/or reproducing apparatus for performing the method.

The present invention also provides a method of automatically optimizing writing conditions of an optical recording medium by considering cross-erase during writing and an optical recording and/or reproducing apparatus for performing the method.

The present invention also provides an automatic writing optimization method suitable for a CD, a DVD, and a next generation high-density disc and an optical recording and/or reproducing apparatus for performing the method.

The present invention also provides a method of using combinations of new write patterns for optimizing writing to simplify a circuit and reduce an operation time and an optical recording and/or reproducing apparatus for performing the method.

The present invention also provides a method of automatically detecting optimum writing conditions of powers and write patterns by calibrating asymmetry, jitter, and a magnitude of a RF signal and an optical recording and/or reproducing apparatus for performing the method.

Additional aspects and/or advantages of the invention will be set forth in part in the description which follows and, in part, will be obvious from the description, or may be learned by practice of the invention.

According to an aspect of the present invention, there is provided a method of optimizing recording conditions of an optical recording medium. A test write pattern is recorded in a plurality of tracks. A quality of a radio frequency signal reproduced from one of the plurality of tracks of the optical recording medium in which the test write pattern is recorded and which is effected by writing in adjacent tracks is checked to determine the recording conditions.

The test write pattern includes a combination of marks of two different lengths, i.e., a mark of minimum length T, where T is a cycle of a recording and/or reproducing clock, and a mark of length T where a power is saturated due to the formation of marks, and a space, or includes a combination of marks of two or more different lengths and a space. Here, when an RLL (1, 7) code is used, the test write pattern may include a combination of marks of two different lengths, i.e., a mark of length 2T and a mark of length 5T, and a space, or includes a combination of marks of two or more different lengths and a space 4. When an RLL (2, 10) code is used, the test write pattern may include a combination of marks of two different lengths, i.e., a mark of length 3T and a mark of length 6T, and a space, or includes a combination of marks of two or more lengths and a space.

The checking of the quality of the radio frequency signal may further comprise optimizing power conditions for the test write pattern using a magnitude of the radio frequency signal.

The checking of the quality of the radio frequency signal may further comprise optimizing a condition of the write pattern using the magnitude of the radio frequency signal.

The checking of the quality of the radio frequency signal may further comprise optimizing a condition of the write pattern using an asymmetry value of the radio frequency signal The checking of the quality of the radio frequency signal may further comprise optimizing a condition of the write pattern using a jitter value of the radio frequency signal.

According to another aspect of the present invention, there is provided a method of determining optimum powers necessary for recording by performing test recording on an optical recording medium. A test write pattern is recorded in a plurality of tracks of the optical recording medium. The optimum powers are determined using a magnitude of a radio frequency signal reproduced from one of the plurality of tracks in which the test write pattern is recorded and which is effected by writing in adjacent tracks.

The method may further include setting the optimum powers determined in the determination of the optimum power and recording the test write pattern, reproducing the test write pattern recorded on the optical recording medium to output the radio frequency signal, and determining the write pattern using the magnitude of the radio frequency signal.

The method may further include determining the test write pattern using an asymmetry value of the radio frequency signal.

The method may further include determining the test write pattern using a jitter value of the radio frequency signal.

According to still another aspect of the present invention, there is provided a method of determining a write pattern by performing test recording on an optical recording medium. A test write pattern is recorded. The test write pattern recorded on the optical recording medium is reproduced to output a radio frequency signal. A write pattern is determined using a magnitude of the radio frequency signal.

The method may further include determining the write pattern using an asymmetry value of the radio frequency signal.

The method may further include determining the write pattern using a jitter value of the radio frequency signal.

According to yet another aspect of the present invention, there is provided method of determining a write pattern by performing test recording on an optical recording medium. The method includes: fixing a first write pattern element indicating a width of a first pulse and a second write pattern element indicating a width of multi-pulses, setting a third write pattern element indicating a shift amount of a starting edge of the first pulse, and setting a fourth write pattern element indicating a period of time for which a cooling pulse lasts to record a test write pattern; reproducing the test write pattern to output a radio frequency signal; detecting an asymmetry of the radio frequency signal; detecting an envelope of the radio frequency signal; and determining the third write pattern element using the asymmetry of the radio frequency signal and determining the fourth write pattern element using the envelope of the radio frequency signal.

According to yet another aspect of the present invention, there is provided an optical recording and/or reproducing apparatus. The optical recording and/or reproducing apparatus includes a pickup & a radio frequency signal detector that records a test write pattern in one or more tracks and reproduces the test write pattern recorded in one of the tracks effected by writing in adjacent tracks, a first detector that detects a magnitude of a radio frequency signal, and a system controller that determines optimum powers using the magnitude of the radio frequency signal.

The optical recording and/or reproducing apparatus may further include a second detector that detects an asymmetry of the radio frequency signal and a third detector that detects a jitter of the radio frequency signal.

According to yet another aspect of the present invention, there is provided a method of optimizing recording on an optical recording medium using a fast growth method or nucleation dominant method for writing thereon. The method includes recording a test write pattern in a plurality of tracks of the optical recording medium and checking a quality of a radio frequency signal reproduced from one of the plurality of tracks in which the write pattern is recorded and which is effected by writing in adjacent tracks to determine the optimized recording conditions.

### BRIEF DESCRIPTION OF THE DRAWINGS

These and/or other aspects and advantages of the invention will become apparent and more readily appreciated from the following description of embodiments taken in conjunction with the accompanying drawings in which:

FIG. 1 is a block diagram of an optical recording and/or reproducing apparatus according to an embodiment of the present invention;

FIGS. 2A through 2D are graphs for explaining a method of determining an erase power, in accordance with an embodiment of the present invention;

FIGS. 3A through 3C are graphs for explaining a method of determining a write power, in accordance with an embodiment of the present invention;

FIGS. 4A through 4C are graphs for explaining a method of determining a bias power, in accordance with an embodiment of the present invention;

FIG. 5 is a graph illustrating jitter caused by cross-erase;

FIGS. 6A and 6B are views illustrating write condition elements, in accordance with an embodiment of the present invention;

FIGS. 7A through 7D are graphs for explaining illustrating a method of determining a write pattern based on a write pattern element dT2 indicating a period of time for which a cooling pulse lasts, according to an embodiment of the present invention;

FIGS. 8A through 8C are graphs for explaining a method of determining a write pattern based on a write pattern element dT1 indicating a shift amount of a starting edge of a first pulse according to an embodiment of the present invention;

FIG. 9 is a flowchart of a method of automatically optimizing writing on an optical recording medium to determine powers, according to an embodiment of the present invention; and

FIG. 10 is a flowchart of a method of automatically optimizing writing on an optical recording medium to determine a write pattern according to an embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

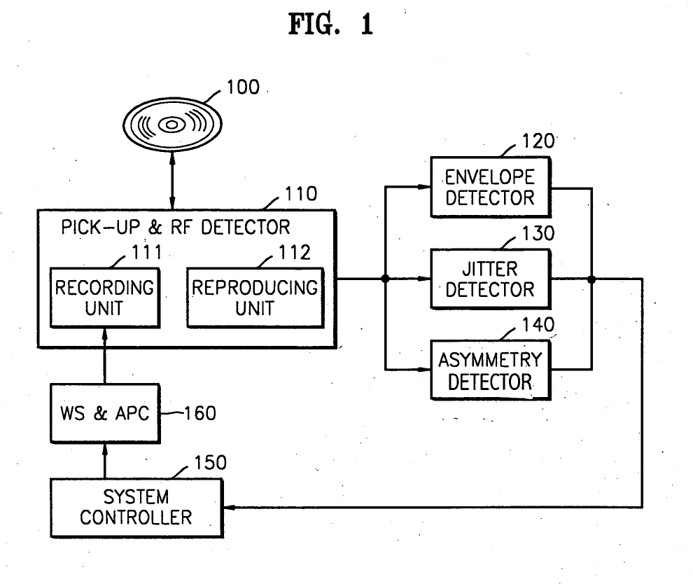

FIG. 1 is a block diagram of an optical recording and/or reproducing apparatus according to an embodiment of the present invention. Referring to FIG. 1, a pick-up & radio frequency (RF) detector 110 records data on and reproduces data from an optical recording medium, e.g., a disc 100. The pick-up and RF detector 110 includes a recording unit 111 and a reproducing unit 112. The recording unit 111 shapes a laser beam emitted from a laser diode (not shown) into write pulses on the disc 100 via an optical system (not shown). The reproducing unit 112 converts an optical signal reflected from the disc 100 into an electric signal via the optical system and detects an RF signal (called a reproduction signal) using the electric signal.

In performing an automatic writing optimization method according to an embodiment of the present invention, a system controller 150 performs writing to test characteristic powers. The system controller 150 sets a standard write power Pw, a standard erase power Pe, and a standard bias power Pbw. Thereafter, the system controller 150 gives a command to a write strategy (WS) & automatic power controller (APC) 160 to sequentially record a test write pattern (hereinafter referred to as a 2T+5T pattern) having a combination of marks of lengths 2T and 5T (T is a bit gap) and a space in a plurality of tracks (here, three tracks) of a test zone of the disc 100 via the recording unit 111 in order to prevent cross-erase caused by a writing operation.

Here, the 2T+5T pattern is used as the test write pattern in the automatic writing optimization method according to the present embodiment of the present invention because the mark of minimum length 2T is affected by a non-optimized power (in particular, a write power) and the mark of long length 5T in which the write power is saturated is hardly or scantly affected by the non-optimized power. In the present embodiment, the 2T+5T pattern is used to employ asymmetry indicating a ratio of a short mark length T to a long mark length T.

The reproducing unit 112 reproduces a write pattern recorded in a middle track of the three tracks, which is affected during writing in tracks adjacent to the middle track. An envelope detector 120 detects an envelope of the RF signal reproduced by the reproducing unit 112 and outputs to the system controller 150 a maximum amplitude value, i.e., a peak-to-peak value I5 pp of the RF signal for the mark of length 5T. The system controller 150 stores a maximum amplitude value I5 pp detected from the standard writer power Pw, the standard erase power Pe, and the standard bias power Pbw output from the envelope detector 120, sequentially varies the standard writer power Pw, the standard erase power Pe, and the standard bias power Pbw, e.g., fixes the bias power Pbw to be 0.1 mW and the write power to be 4.7 mW and varies the erase power Pe within a range of 1.5 mW-2.5 mW, and rewrites and/reproduces the test write pattern according to the above-described process. Here, a process of comparing the maximum amplitude value I5 pp detected by the envelope detector 120 with the maximum amplitude value I5 pp obtained from the standard writer power Pw, the standard erase power Pe, the standard bias power Pbw stored in the system controller 150 is repeated to determine an erase power Pe having the maximum amplitude value I5 pp as an optimum erase power. Optimum write and bias powers for the standard write and bias powers Pw and Pbw are also determined according to the above-described process.

When the optimum powers Pw, Pe, and Pbw are determined, the system controller 150 records the test write pattern. First, after a standard write pattern is set, a write pattern element T1 indicating the width of a first pulse and a write pattern element T2 indicating the width of multi-pulses are fixed to predetermined values, and a write pattern element dT1 indicating the shift amount of a starting edge of the first pulse is set to a variable parameter. Thereafter, the 2T+5T pattern is recorded one time. The recorded 2T+5T pattern is reproduced to output an asymmetry value detected by an asymmetry detector 140 and a set value of the write pattern element dT1 at that time to the system controller 150. The system controller 150 records and/or reproduces the 2T+5T pattern while varying the write pattern element dT1 within a predetermined range. Thereafter, the system controller 150 compares the asymmetry value detected by the asymmetry detector 140 with a previously input asymmetry value and determines the write pattern element dT1 measured when the detected asymmetry value is minimum as an optimum write pattern element dT1. Using the above-described method, the system controller 150 also sets a write pattern element dT2 indicating a period of time for which a cooling pulse lasts to a variable parameter, records and/or reproduces the 2T+5T pattern, and determines the write pattern element dT2 measured when the peak-to-peak value I5 pp detected by the envelope detector 120 is maximum as an optimum write pattern element dT2.

After fixing the determined optimum write pattern elements dT1 and dT2, the system controller 150 records and/or reproduces the 2T+5T pattern while varying each of the write pattern element dT1 indicating the width of the first pulse and the write pattern element dT2 indicating the width of the multi-pulses within a predetermined range. Next, the system controller 150 determines the write pattern elements T1 and T2 measured when jitter detected by a jitter detector 130 is minimum as optimum write pattern elements T1 and T2.

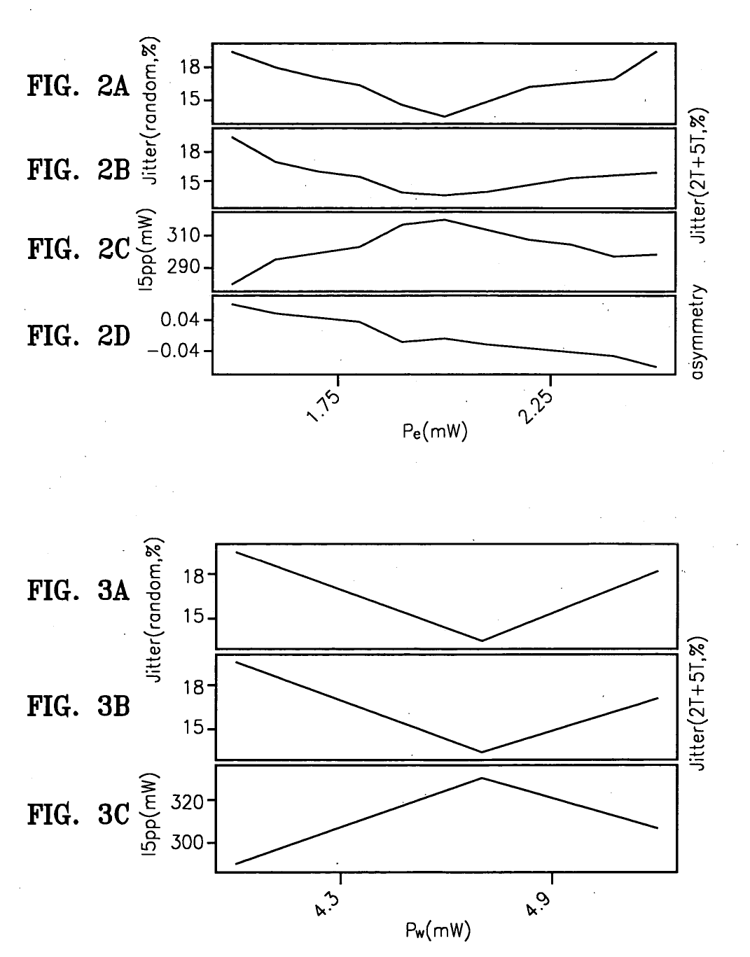

FIG. 2A illustrates jitter in a random pattern due to the erase power Pe, FIG. 2B illustrates jitter in the 2T+5T pattern due to the erase power Pe, FIG. 2C illustrates the relationship between jitter and the maximum amplitude value I5 pp of the RF signal for the mark of length 5T due to the erase power Pe, and FIG. 2D illustrates the relationship between the erase power Pe and asymmetry.

As can be seen in FIGS. 2A and 2B, the random pattern and the 2T+5T pattern have the same recording and/or reproducing characteristic. As can be seen in FIG. 2C, when jitter is minimized, the RF signal has the maximum amplitude value I5 pp. Here, as can be seen in FIG. 2D, an asymmetry value is within a predetermined range. Thus, in the present embodiment of the present invention, an erase power measured when the 2T+5T pattern is recorded and then the RF signal has the maximum amplitude value I5 pp, is determined as an optimum erase power Pe.

FIG. 3A illustrates jitter in the random pattern due to the write power Pw, FIG. 3B illustrates jitter in the 2T+5T pattern due to the write power Pw, and FIG. 3C illustrates the relationship between the write power Pw and the maximum amplitude value I5 pp of the RF signal for the mark of length 5T.

As can be seen in FIGS. 3A and 3B, the random pattern has the same recording and/or reproducing characteristic as the 2T+5T pattern when the write power Pe is applied, as when the erase power Pe was applied. As can be seen in FIG. 3C, the RF signal has the maximum value I5 pp when jitter is minimized. Accordingly, in the present embodiment of the present invention, the write power Pw measured when the 2T+5T pattern is recorded and the RF signal has the maximum value I5 pp, is determined as an optimum write power.

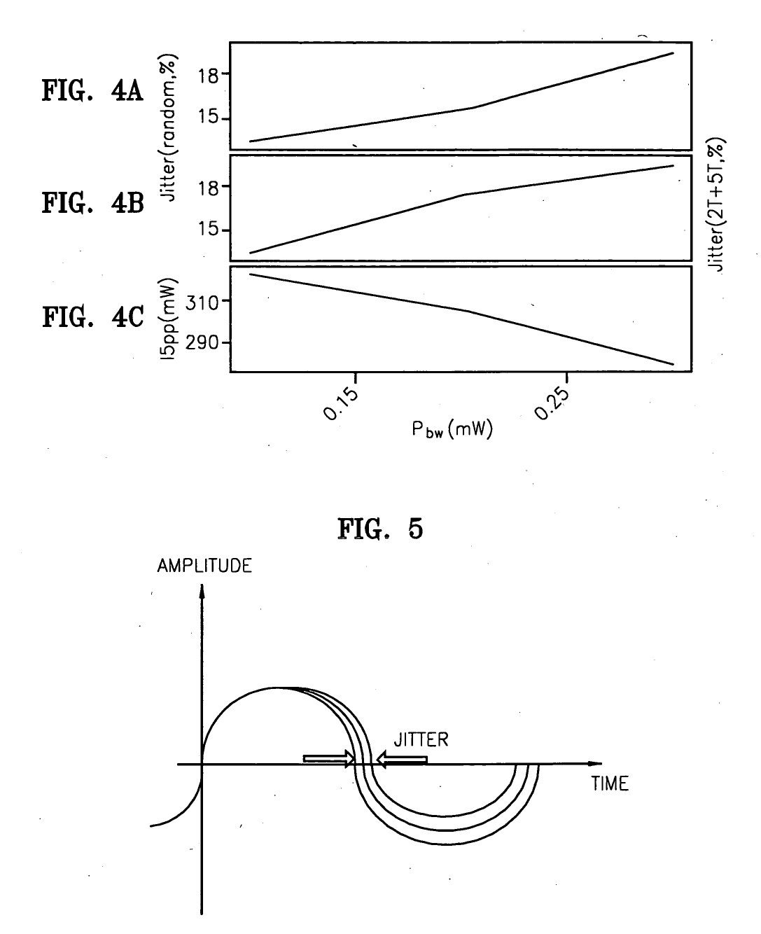

FIG. 4A illustrates jitter in the random pattern due to the bias power Pbw, FIG. 4B illustrates jitter in the 2T+5T pattern due to the bias power Pbw, and FIG. 4C illustrates the relationship between the bias power Pbw and the maximum amplitude value I5 pp of the RF signal for the mark of length 5T.

As can bee seen in FIGS. 4A and 4B, the random pattern has the same recording and/or reproducing characteristic as the 2T+5T pattern even when the bias power Pbw is applied as when the erases power Pe and the write power Pw were applied. As can be seen in FIG. 4C, the RF signal has the maximum amplitude value I5 pp when jitter is minimized. Accordingly, in the present embodiment of the present invention, the bias power Pbw measured when the 2T+5T pattern is recorded and the RF signal has the maximum amplitude value I5 pp, is determined as an optimum bias power.

In conclusion, the erase power Pe, the write power Pw, and the bias power Pbw used for recording have the same recording and/or reproducing characteristic according to jitter. Thus, a write pattern is recorded and reproduced while sequentially varying the erase power Pe, the write power Pw, and the bias power Pbw. Next, the erase power Pe, the write power Pw, and the bias power Pbw measured when the RF signal has the maximum amplitude value I5 pp are determined as optimum erase, write, and bias powers. For example, after the bias power Pbw is fixed to 0.1 mW, the write power to 4.7 mW, and the erase power Pe is adjusted within a range of 1.5 mW-2.5 mW, the erase power Pe measured when the RF signal has the maximum amplitude value I5 pp is determined as an optimum erase power Pe. After the bias power Pbw and the determined optimum erase power Pe are fixed and the write power Pw is adjusted, the write power Pw measured when the RF signal the maximum value I5 pp is determined as an optimum write power Pw. After the determined erase power Pe and write power Pw are fixed and the bias power Pbw is adjusted, the bias power Pbw measured when the RF signal has the maximum amplitude value I5PP is determined as an optimum bias power Pbw.

FIG. 5 is a graph illustrating an effect of jitter occurring while the write pattern recorded in an adjacent track is erased with an increase in the write power Pw when the write pattern and the erase, write, and bias powers Pe, Pw, and Pbw are not optimized. In other words, a cross-erase phenomenon occurs when the write pattern is recorded in an adjacent track, which causes jitter.

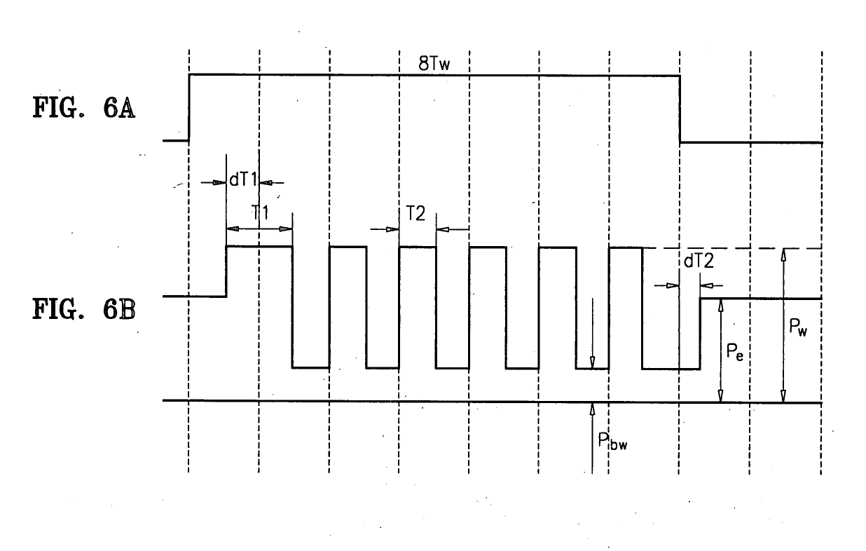

A mark having a predetermined length (8Tw in FIG. 6A) may be recorded in a write pulse form on a disc as shown in FIG. 6B. FIG. 6B illustrates optical powers and write condition elements for write pattern, and the like. Write pulses include a first pulse having a write power Pw and a last pulse (called a cooling pulse) having a bias power Pbw. A train of multi-pulses, the number of which varies depending on a bit gap Tw, exists between the first pulse and the cooling pulse. Also, the erase power Pe is needed for a space period. T1 is a write pattern element indicating the width of the first pulse, dT1 is a shift amount of a starting edge of the first pulse, T2 is a write pattern element indicating the width of the multi-pulses, and dT2 is a write pattern element indicating a period of time for which the cooling pulse lasts.

A write pattern having a write pulse form as well as optical powers should be optimized in order to obtain stable writing quality during optical recording. The optimization of the write pattern depends on a recording and/or reproducing apparatus and the characteristics of a recording medium. Thus, the structure of the write pattern shown in FIG. 6B and the optical powers necessary for recording have to be automatically determined. In particular, the cross-erase phenomenon caused by high-density recording has to be minimized. In order to achieve these objects, high-speed optimization should be attained with a simple circuit structure. Thus, a new test write pattern having the same recording and/or reproducing characteristic as an actual write pattern is required.

Accordingly, the present embodiment of the present invention uses a test write pattern having a minimum mark length T and a mark length T where a power is saturated due to the formation of marks. A modulation code, which is mainly used in a data storage system such as a magnetic recording system, an optical disc drive, or the like, is a run-length-limited (RLL) code which limits the minimum number of successive zeros between 1 s to “d” and the maximum number of the same to “k”. When a RLL (1, 7) code is used, the test write pattern may be composed of] a combination of marks of two different lengths, i.e., a minimum length T (here, 2T) and a length T (here, 5T) in which a power is saturated due to the formation of marks, or a combination of marks of two or more different lengths. Optical recording media using the RLL (1, 7) code are high-density recording media such as HD-DVDs or HD-DVD Rewritables.

When a RLL (2, 10) code is used, the test write pattern may be a combination of marks of two different lengths, i.e., a minimum length T (here, 3T) and a length T (here, 6T) in which a power is saturated due to the formation of marks, or a combination of marks of two or more different lengths. Optical recording media using the RLL (2, 10) code are recording media such as CD- and DVD-family recording media.

In the disclosed embodiments of the present invention, a write pattern having a mark of minimum length 2T and a mark of length 5T is used for optimization.

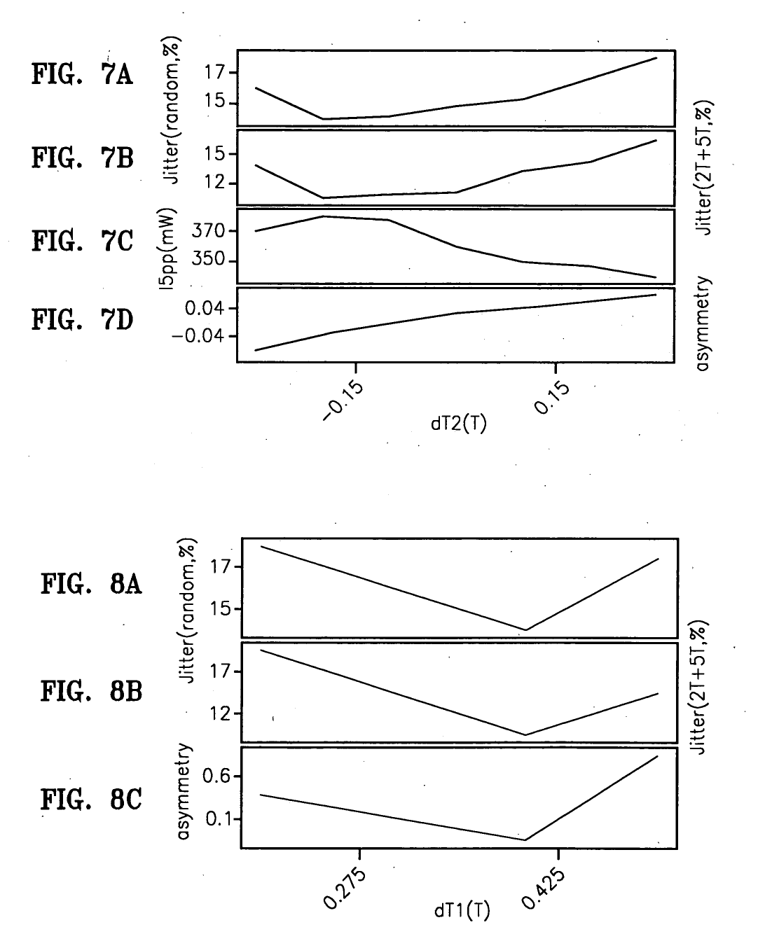

FIG. 7A illustrates jitter in a random pattern according to variations in the write pattern element dT2 indicating of a period of time for which the cooling pulse lasts, FIG. 7B illustrates jitter in the 2T+5T pattern according to variations in the write pattern element dT2, FIG. 7C illustrates the relationship between the variations in the write pattern element dT2 and the maximum amplitude value I5 pp of the RF signal for the mark of length 5T, and FIG. 7D illustrates the relationship between the variation in the write pattern element dT2 and asymmetry.

As can bee seen in FIGS. 7A and 7B, the random pattern and the 2T+5T pattern have the same recording and/or reproducing characteristic. As can be seen in FIG. 7C, the RF signal has the maximum amplitude value I5 pp when jitter is minimized. Here, an asymmetry value shown in FIG. 7D is within a predetermined range. Accordingly, an optimum write pattern element dT2 can be determined when the RF signal has the maximum amplitude value I5 pp.

FIG. 8A illustrates jitter in the random pattern according to variations in the write pattern element dT1 indicating the shift amount of the starting edge of the first pulse, FIG. 8B illustrates jitter in the 2T+5T pattern according to the variations in the write pattern element dT1, and FIG. 8C illustrates the relationship between the variations in the write pattern element dT1 and asymmetry.

As shown in FIGS. 8A and 8B, the random pattern and the 2T+5T pattern have the same recording and/or reproducing characteristic. As can bee seen in FIG. 8C, when the write pattern element dT1 varies, the asymmetry is minimum at a point of time when jitter is minimized. Accordingly, an optimum write pattern element dT1 can be determined when the asymmetry is minimized.

An optimum write pattern element T1 indicating the width of the first pulse and an optimum write pattern element T2 indicating the width of the multi-pulses can be determined at a point of time when jitter in the 2T+5T pattern is minimized.

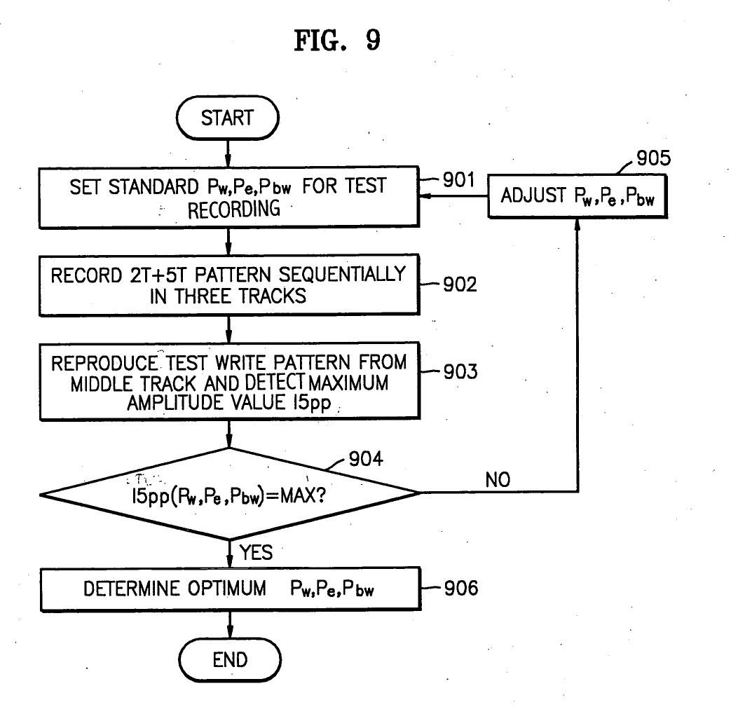

FIG. 9 is a flowchart illustrating a method of automatically optimizing writing on an optical recording medium to determine powers according to an embodiment of the present invention. The method will be described with concurrent reference to FIG. 1. Referring to FIG. 9, in operation 901, a standard write power Pw, a standard erase power Pe, and a standard bias power Pbw for test writing are set. In operation 902, a test write pattern including a combination of a mark of length 2T and a mark of length 5T is recorded sequentially in a plurality of tracks (here, three tracks) of a test zone of the disc 100 in order to check an effect of cross-erase. In operation 903, the test write pattern is reproduced from the middle track of the three tracks and a maximum amplitude value I5 pp of an RF signal for the mark of length 5T is detected by the envelope detector 120. In operation 904, whether the RF signal does not have the maximum amplitude value I5 pp at the standard write power Pw, the standard erase power Pe, and the standard bias power Pbw is determined, and if the RF signal has the maximum amplitude value I5 pp, in operation 905, the standard write power Pw, the standard erase power Pe, and the standard bias power Pbw are adjusted and operations 901-904 are repeated.

For example, by fixing the standard write power Pw and the bias power Pbw and adjusting the erase power Pe within a predetermined range, operations 902 through 905 are repeated until the RF signal has the maximum amplitude value I5 pp detected by the envelope detector 120. In operation 906, the erase power Pe measured when the RF signal has the maximum amplitude value I5 pp is determined to be an optimum erase power. Thereafter, after the determined erase power Pe and the standard bias power Pbw are fixed and the standard write power Pw is adjusted within a predetermined range, operations 902 through 905 are repeated until the RF signal has the maximum amplitude value I5 pp detected by the envelope detector 120. In operation 905, the write power Pw measured when the RF signal has the maximum amplitude value I5 pp is determined to be an optimum write power. Finally, after the determined write power Pw and the determined erase power Pe are fixed and the standard bias power Pbw is adjusted within a predetermined range, operations 902 through 905 are repeated until the RF signal has the maximum amplitude value I5 pp detected by the envelope detector 120. In operation 906, the bias power Pbw measured when the RF signal has the maximum amplitude value I5 pp is determined to be an optimum bias power. Although a specific order of adjusting the standard erase power Pe, the standard write power Pw, and the standard bias power Pbw has been explained, it is to be understood that the order may be altered according to myriad factors including for example, a nianufacturer's design choice.

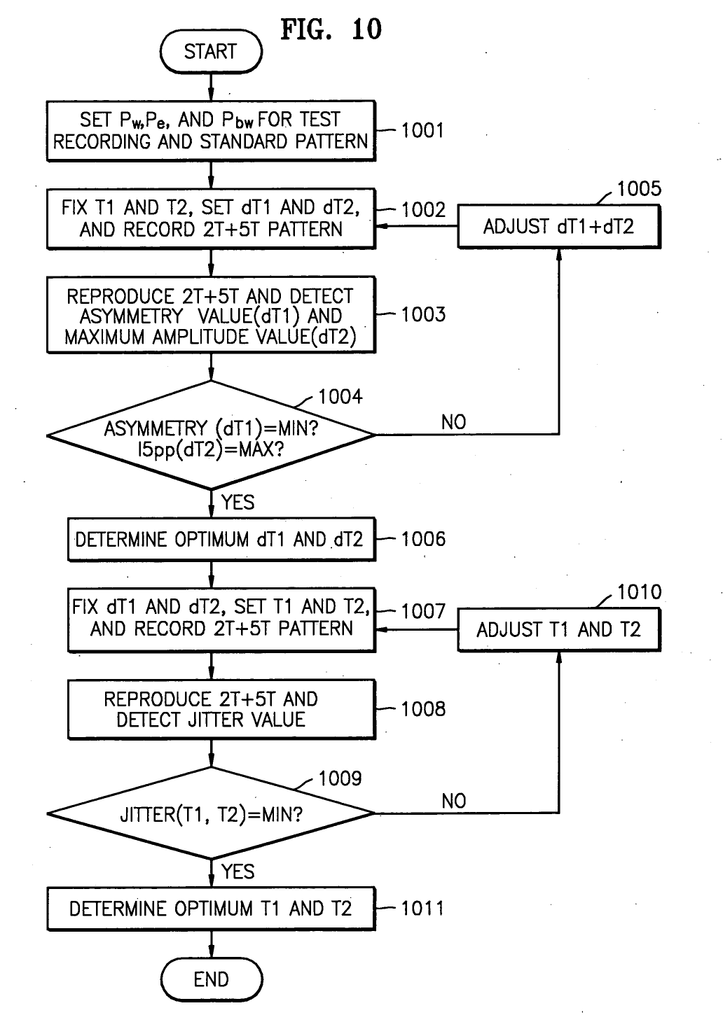

FIG. 10 is a flowchart of a method of automatically optimizing writing on an optical recording medium to determine a write pattern. The method will be described with concurrent reference to FIG. 1.

Referring to FIG. 10, in operation 1001, write, erase, and bias powers Pw, Pe, and Pbw, respectively, for test recording are set and a standard pattern is set. Here, the write, erase, and bias powers Pw, Pe, and Pbw may be set to the optimum write, erase, and bias powers Pw, Pe, and Pbw determined according the method presented in FIG. 9. However, the write, erase, and bias powers Pw, Pe, and Pbw may be set to standard write, erase, and bias powers Pw, Pe, and Pbw, respectively.

In operation 1002, the write pattern element T1 indicating the width of the first pulse and the write pattern element T2 indicating the width of multi-pulses are fixed, the write pattern element dT1 indicating the shift amount of the starting edge of the first pulse and the write pattern element dT2 indicating a period of time for which the cooling pulse lasts are set, and a write pattern of a mark of length 2T and a mark of length 5T. Here, the write pattern may be recorded in one track or sequentially in three tracks. Alternatively, in operation 1002, the write pattern elements T1, T2, dT1 may be fixed, the write pattern element dT2 may vary to determine an optimum write pattern element dT2, and the write pattern element dT1 may vary to determine an optimum write pattern element dT1. However, two or more write pattern elements may be simultaneously set to reduce the time required for the optimization.

In operation 1003, the reproducing unit 112 reproduces the 2T+5T pattern recorded in a track to output an RF signal, the asymmetry detector 140 detects an asymmetry value of the RF signal, and the envelope detector 120 detects a maximum amplitude value I5 pp of the RF signal for the mark of length 5T. In operation 1004, an optimum write pattern element dT1 is determined when the asymmetry value determined by the asymmetry detector 140 is minimized, an optimum write pattern element dT2 is determined when the RF signal has the maximum amplitude value I5 pp detected by the envelope detector 120, and whether the asymmetry value is minimized or the RF signal has the maximum amplitude value I5 pp is determined. If the asymmetry value is not minimum or the RF signal does not have the maximum amplitude value I5 pp, in operation 1005, the write pattern element dT1 or dT2 is adjusted operations 102 through 105 are then repeated until the asymmetry value becomes minimum and the RF signal has the maximum amplitude value I5 pp. In operation 1006, optimum write pattern elements dT1 and dT2 are determined when the RF signal has the maximum amplitude value I5 pp.

In operation 1007, the determined optimum write pattern elements dT1 and dT2 are fixed, write pattern elements T1 and T2 are set, and the write pattern including the mark of length 2T and the mark of length 5T is recorded. Here, the write pattern may be recorded in one track or sequentially in a plurality of tracks. Alternatively, the write pattern elements dT1, dT2, and T1 may be fixed, the write pattern element T2 may vary to determine an optimum write pattern element dT2, and the write pattern element dT1 may vary to determine an optimum write pattern element dT1. However, two write pattern elements T1 and T2 are set to reduce the time required for the optimization.

In operation 1008, the reproducing unit 112 reproduces the 2T+5T recorded in a track to output an RF signal and the jitter detector 130 detects jitter in the RF signal. In operation 1009, whether jitter is minimized is determined. If jitter is not minimized, in operation 1010, the write pattern elements T1 and T2 are adjusted. Operations 1007 through 1010 are then repeated until jitter is minimized. In operation 1011, optimum write pattern elements T1 and T2 are determined when jitter detected by the jitter detector 130 is minimized.

As described above, the present invention can automatically optimize writing on an optical recording medium using a fast growth method as well as a nucleation dominant method. The embodiments of present invention can also automatically optimize recording conditions by considering cross-erase during optical recording, be suitable for recordable CDs, DVDs, and HD-DVDs, and in particular, can be applied to recording on HD-DVD-rewritable discs using a high-density recording method. Furthermore, the embodiments of present invention can simplify a circuit and reduce operation time using a test write pattern having the same recording and/or reproducing characteristic as an actual write pattern.

Although a few embodiments of the present invention have been shown and described, the present invention is not limited to the disclosed embodiments. Rather, it would be appreciated by those skilled in the art that changes may be made in this embodiment without departing from the principles and spirit of the invention, the scope of which is defined by the claims and their equivalents.

What is claimed is:

1. A method of optimizing recording conditions of an optical recording medium, comprising:
recording a test write pattern in a plurality of tracks of the optical recording medium; and
checking a quality of a radio frequency signal reproduced from one of the plurality of tracks in which the write pattern is recorded and which is effected by writing in adjacent tracks to determine the optimized recording conditions.

2. The method of claim 1, wherein the test write pattern comprises a combination of marks of two or more different lengths and a space.

3. The method of claim 1, wherein the test write pattern comprises a first mark of length T, and a second mark of length NT which is longer than the first mark and in which power is saturated due to the formation of the marks, and a space, and wherein T is a cycle of a recording and/or reproducing clock and N is an integer.

4. The method of claim 2, wherein, when the optical recording medium uses a run-length-limited (RLL) (1, 7) code, the test write pattern comprises a combination of marks of two or more different lengths and a space.

5. The method of claim 2, wherein, when the optical recording medium uses an RLL (1, 7) code, the test write pattern comprises a mark of length 2T and a mark of length 5T, and a space.

6. The method of claim 2, wherein, when the optical recording medium uses a run-length-limited (RLL) (2, 6) code, the test write pattern comprises a combination of marks of two or more different lengths and a space.

7. The method of claim 2, wherein, when the optical recording medium uses a run-length-limited (RLL) (2, 10) code, the test write pattern comprises a mark of length 3T and a mark of length 6T, and a space.

8. The method of claim 1, wherein the checking further comprises optimizing power conditions for the test write pattern using a magnitude of the radio frequency signal.

9. The method of claim 1, wherein the checking further comprises optimizing a condition of the write pattern using the magnitude of the radio frequency signal.

10. The method of claim 1, wherein the checking further comprises optimizing a condition of the write pattern using an asymmetry value of the radio frequency signal.

11. The method of claim 1, wherein the checking further comprises optimizing a condition of the write pattern using a jitter value of the radio frequency signal.

12. A method of determining optimum powers necessary for recording by performing test recording on an optical recording medium, comprising:
recording a test write pattern in a plurality of tracks of the optical recording medium; and
determining the optimum powers using a magnitude of a radio frequency signal reproduced from one of the plurality of tracks effected by writing in adjacent tracks.

13. The method of claim 12, wherein the test write pattern comprises a combination of marks of two or more different lengths and a space.

14. The method of claim 12, wherein the test write pattern comprises a first mark of length T, and a second mark of length NT which is longer than the first mark and in which power is saturated due to the formation of the marks, and a space, and wherein T is a cycle of a recording and/or reproducing clock and N is an integer.

15. The method of claim 13, wherein, when the optical recording medium uses a run-length-limited (RLL) (1, 7) code, the test write pattern comprises a combination of marks of two or more different lengths and a space.

16. The method of claim 13, wherein, when the optical recording medium uses an RLL (1, 7) code, the test write pattern comprises a mark of length 2T and a mark of length 5T, and a space.

17. The method of claim 13, wherein, when the optical recording medium uses a run-length-limited (RLL) (2, 6) code, the test write pattern comprises a combination of marks of two or more different lengths and a space.

18. The method of claim 13, wherein, when the optical recording medium uses a run-length-limited (RLL) (2, 10) code, the test write pattern comprises a mark of length 3T and a mark of length 6T, and a space.

19. The method of claim 12, wherein the magnitude of the radio frequency signal is determined to be a peak-to-peak value of a radio frequency signal for a mark of length T of the test write pattern in which a power is saturated due to the formation of marks.

20. The method of claim 12, wherein the determining comprises:
reproducing the test write pattern recorded in a middle track of the plurality of tracks effected by writing on adjacent tracks to output a radio frequency signal; and
fixing two of write, bias, and erase powers and varying the other one of the write, bias, and erase powers within a range to determine optimum write, bias, and erase powers when the magnitude of the radio frequency signal is at a maximum.

21. The method of claim 12, wherein the recording comprises:
setting standard write, erase, and bias powers for recording the test write pattern; and
recording the test write pattern in the plurality of tracks.

22. The method of claim 21, wherein the determining comprises:
reproducing, by a radio frequency signal, the write pattern recorded in a middle track of the plurality of tracks effected by writing on adjacent tracks;
detecting an envelope of the radio frequency signal to detect a maximum amplitude of the radio frequency signal;
fixing the write and bias powers and varying the erase power within a range to determine whether the magnitude of the radio frequency signal is the maximum amplitude value,
wherein, when the magnitude of the radio frequency is not the maximum amplitude, repeating the reproducing, detecting, and fixing, and wherein, when the magnitude of the radio frequency is the maximum amplitude value, determining the erase power is an optimum erase power.

23. The method of claim 22, wherein the determining further comprises:
fixing the bias power and the optimum erase power and varying the write power within a range to determine whether the magnitude of the radio frequency signal is the maximum amplitude value,
wherein, when the magnitude of the radio frequency signal is not the maximum amplitude, repeating the reproducing, detecting, and fixing, and wherein, when the magnitude of the radio frequency signal is the maximum amplitude value, determining the write power is an optimum write power.

24. The method of claim 23, wherein the determining further comprises:
fixing the optimum erase power and the optimum write power and varying the bias power within a range to determine whether the magnitude of the radio frequency signal is the maximum amplitude value,
wherein, when the magnitude of the radio frequency signal is not the maximum amplitude, repeating the reproducing, detecting, and fixing, and wherein, when the magnitude of the radio frequency signal is the maximum amplitude value, determining the bias power is an optimum bias power.

25. The method of claim 12, further comprising:
setting the optimum powers determined in the determining and recording the test write pattern;
reproducing the test write pattern recorded on the optical recording medium to output the radio frequency signal; and
determining the test write pattern using the magnitude of the radio frequency signal.

26. The method of claim 25, wherein in the test write pattern determining, when the magnitude of the radio frequency signal is a maximum amplitude, a write pattern element indicating a period of time for which a cooling pulse lasts is determined.

27. The method of claim 25, further comprising determining the test write pattern using an asymmetry value of the radio frequency signal.

28. The method of claim 27, wherein in the test write pattern determining, when the asymmetry value of the radio frequency signal is at a minimum, a write pattern element indicating a shift amount of a starting edge of a first pulse is determined.

29. The method of claim 25, further comprising determining the write pattern using a jitter value of the radio frequency signal.

30. The method of claim 29, wherein in the determining the write pattern using a jitter value, when the jitter value of the radio frequency signal is a minimum, a write pattern element indicating a width of the first plus is determined.

31. The method of claim 29, wherein in the test write pattern determining, when the jitter value of the radio frequency signal is a minimum, a write pattern element indicating a width of multi-pluses is determined.

32. A method of determining a write pattern by performing test recording on an optical recording medium, comprising:
recording a test write pattern on the optical recording medium;
reproducing the test write pattern to output a radio frequency signal; and
determining a write pattern using a magnitude of the radio frequency signal.

33. The method of claim 32, wherein the test write pattern comprises a combination of marks of two or more different lengths and a space.

34. The method of claim 32, wherein the test write pattern comprises a first mark of length T, and a second mark of length NT which is longer than the first mark and in which power is saturated due to the formation of the marks, and a space, and wherein T is a cycle of a recording and/or reproducing clock and N is an integer.

35. The method of claim 33, wherein, when the optical recording medium uses a run-length-limited (RLL) (1, 7) code, the test write pattern comprises a combination of marks of two or more different lengths and a space.

36. The method of claim 33, wherein, when the optical recording medium uses an RLL (1, 7) code, the test write pattern comprises a mark of length 2T and a mark of length 5T, and a space.

37. The method of claim 33, wherein, when the optical recording medium uses a run-length-limited (RLL) (2, 6) code, the test write pattern comprises a combination of marks of two or more different lengths and a space.

38. The method of claim 33, wherein, when the optical recording medium uses a run-length-limited (RLL) (2, 10) code, the test write pattern comprises a mark of length 3T and a mark of length 6T, and a space.

39. The method of claim 32, wherein in the determining, when the magnitude of the radio frequency signal is a maximum amplitude value, a write pattern element indicating a period of time for which a cooling pulse lasts is determined.

40. The method of claim 32, further comprising determining the write pattern using an asymmetry value of the radio frequency signal.

41. The method of claim 40, wherein in the determining the write pattern using an asymmetry value, when the asymmetry value of the radio frequency signal is a minimum, a write pattern element indicating a shift amount of a starting edge of a first pulse is determined.

42. The method of claim 32, further comprising determining the write pattern using a jitter value of the radio frequency signal.

43. The method of clam 42, wherein in the determining the write pattern using a jitter value, when the jitter value of the radio frequency signal is a minimum, a write pattern element indicating a width of the first plus is determined.

44. The method of claim 42, wherein in the determining the write pattern using a jitter value, when the jitter value of the radio frequency signal is a minimum, a write pattern element indicating a width of multi-pluses is determined.

45. A method of determining a write pattern by performing test recording on an optical recording medium, comprising:
fixing a first write pattern element indicating a width of a first pulse and a second write pattern element indicating a width of multi-pulses, setting a third write pattern element indicating a shift amount of a starting edge of the first pulse, and setting a fourth write pattern element indicating a period of time for which a cooling pulse lasts to record a test write pattern;
reproducing the test write pattern to output a radio frequency signal;
detecting an asymmetry of the radio frequency signal;
detecting an envelope of the radio frequency signal; and
determining the third write pattern element using the asymmetry of the radio frequency signal and determining the fourth write pattern element using the envelope of the radio frequency signal.

46. The method of claim 45, further comprising:
detecting a jitter of the radio frequency signal;
fixing the third and fourth write pattern elements, re-setting the first and second write pattern elements, and recording the test write pattern; and
determining the first and second write pattern elements using the jitter of the radio frequency signal.

47. An optical recording and/or reproducing apparatus comprising:
a pickup & a radio frequency signal detector that records a test write pattern in one or more tracks and reproduces the test write pattern recorded in one of the tracks effected by writing in adjacent tracks;
a first detector which detects a magnitude of a radio frequency signal; and
a system controller which determines optimum powers using the magnitude of the radio frequency signal.

48. The optical recording and/or reproducing apparatus of claim 47, wherein the test write pattern comprises a combination of marks of two or more different lengths and a space.

49. The optical recording and/or reproducing apparatus of claim 47, wherein the test write pattern comprises a first mark of length T, and a second mark of length NT which is longer than the first mark and in which power is saturated due to the formation of the marks, and a space, and wherein T is a cycle of a recording and/or reproducing clock and N is an integer.

50. The optical recording and/or reproducing apparatus of claim 48, wherein, when the optical recording medium uses a run-length-limited (RLL) (1, 7) code, the test write pattern comprises a combination of marks of two or more different lengths and a space.

51. The method of claim 48, wherein, when the optical recording medium uses an RLL (1, 7) code, the test write pattern comprises a mark of length 2T and a mark of length 5T, and a space.

52. The optical recording and/or reproducing apparatus of claim 48, wherein, when the optical recording medium uses a run-length-limited (RLL) (2, 6) code, the test write pattern comprises a combination of marks of two or more different lengths and a space.

53. The method of claim 48, wherein, when the optical recording medium uses a run-length-limited (RLL) (2, 10) code, the test write pattern comprises a mark of length 3T and a mark of length 6T, and a space.

53. The optical recording and/or reproducing apparatus of claim 47, wherein the system controller determines optimized write, erase, and bias powers necessary for recording when the radio frequency signal for the test write pattern has a maximum amplitude value.

54. The optical recording and/or reproducing apparatus of claim 47, further comprising:
a second detector which detects an asymmetry of the radio frequency signal; and
a third detector which detects a jitter of the radio frequency signal.

55. The optical recording and/or reproducing apparatus of claim 54, wherein the system controller determines an optimized write pattern element indicating a shift amount of a starting edge of a first pulse using the magnitude of the radio frequency signal for the test write pattern.

56. The optical recording and/or reproducing apparatus of claim 54, wherein the system controller determines an optimized write pattern element indicating a period of time for which a cooling pulse lasts using the asymmetry of the radio frequency signal for the test write pattern.

57. The optical recording and/or reproducing apparatus of claim 54, wherein the system controller determines an optimized width of the first pulse using the jitter of the radio frequency signal.

58. The optical recording and/or reproducing apparatus of claim 54, wherein the system controller determines an optimized width of multi-pulses using the jitter of the radio frequency signal.

59. A method of optimizing recording on an optical recording medium using a fast growth method or nucleation dominant method for writing thereon, comprising:
recording a test write pattern in a plurality of tracks of the optical recording medium; and
checking a quality of a radio frequency signal reproduced from one of the plurality of tracks in which the write pattern is recorded and which is effected by writing in adjacent tracks to determine the optimized recording conditions.
